(19) United States
(12) Patent Application Publication
(10) Pub. No.: US 2025/0178382 A1
(43) Pub. Date: Jun. 5, 2025

(54) SENSOR DEVICE AND METHOD FOR MONITORING TIRE

(71) Applicant: HL KLEMOVE CORPORATION, Incheon (KR)

(72) Inventors: Chang-Won KIM, Incheon (KR); Dae-Youn YUN, Incheon (KR); Ye-Chan JANG, Incheon (KR)

(21) Appl. No.: 18/919,862

(22) Filed: Oct. 18, 2024

(30) Foreign Application Priority Data
Dec. 4, 2023 (KR) 10-2023-0173590
Apr. 23, 2024 (KR) 10-2024-0053948

(51) Int. Cl. B60C 23/04; G01D 21/02

(52) U.S. Cl. CPC B60C 23/0488; G01D 21/02

(57) ABSTRACT

The present disclosure provides a sensor device for monitoring a tire including a sensor that is mounted inside a tire and measuring a pressure and temperature inside the tire and an acceleration according to tire rotation, a memory that stores pressure data, temperature data, and acceleration data measured by the sensor, a processor that varies a transmission period of at least one of the pressure data, the temperature data, and the acceleration data based on the acceleration data, and a transmitter that transmits at least one of the pressure data, the temperature data, and the acceleration data according to the transmission period.

### CROSS-REFERENCE TO RELATED APPLICATION

This application claims priority to and the benefit from Korean Patent Application No. 10-2023-0173590, filed on Dec. 4, 2023, and No. 10-2024-0053948, filed on Apr. 23, 2024, the disclosures of which is incorporated herein by reference in its entirety.

### BACKGROUND

### Technical Field

The present disclosure relates to a sensor device and method for monitoring a tire (hereinafter, it is referred to as a ‘tire monitoring sensor device and method’), and more particularly, to a tire monitoring sensor device and method for varying a data transmission period.

### Description of Related Art

Tires are the only vehicle components that come in contact with the road surface, and play a very important role in relation to the driving performance and safety of the vehicle because they generate the vehicle's turning, driving, and braking forces to enable the vehicle to travel.

A conventional tire pressure monitoring sensor (TPMS) is configured to include a pressure sensor and a temperature sensor, and measures the air pressure and the temperature of the tire, and the battery voltage of the sensor using these sensors, and transmits the air pressure state of the tire to a controller mounted on the vehicle using wireless communication at a specific period.

Recently, a tire monitoring sensor (TMS) including a pressure sensor, a temperature sensor, and an acceleration sensor is embedded in the tire to measure tire-imposed load, tire mileage, and road surface characteristics, and the like.

However, unlike the conventional tire pressure monitoring sensor, the tire monitoring sensor (TMS) has a disadvantage in that it has a large physical quantity to be measured, operates at high sampling for precise measurement, and has a short data transmission period, so the sensor's battery is consumed in a short time.

### BRIEF SUMMARY

The present disclosure is to solve the problems as above, and it is an object of the present disclosure to estimate a tire rotation period, a road surface state, and whether to change a road surface state using acceleration data measured by the sensor, and vary a data transmission period, so that only necessary data is transmitted, and unnecessary data transmission is suppressed to reduce power consumption of the sensor to maximize lifespan of the battery.

The technical problems of the present disclosure are not limited to the above-mentioned technical problems, and other technical problems not mentioned herein may be clearly understood by those skilled in the art from the following description.

In order to solve the above problems, the present disclosure provides a tire monitoring sensor device comprising a sensor configured to measure a pressure and temperature inside a tire, and an acceleration according to rotation of the tire, a memory configured to store pressure data, temperature data, and acceleration data measured by the sensor, a processor configured to vary a transmission period of at least one of the pressure data, the temperature data, or the acceleration data based on the acceleration data, and a transmitter configured to transmit at least one of the pressure data, the temperature data, or the acceleration data according to the transmission period.

The processor may calculate a rotation speed of the tire based on the acceleration data.

The processor may vary the transmission period based on the rotation speed of the tire.

The processor may determine road surface characteristics based on the acceleration data.

The processor may determine whether the road surface characteristics change based on the acceleration data.

The processor may control the transmitter to transmit at least one of the pressure data, the temperature data, and the acceleration data based on the change in the road surface characteristics.

The memory may store the transmission period set differently depending on the rotation speed of the tire.

The memory may store reference acceleration data corresponding to the road surface characteristics.

The processor may determine the road surface characteristics by comparing the acceleration data with the reference acceleration data.

The present disclosure provides a tire monitoring method using a sensor device comprising measuring a pressure and temperature inside a tire and an acceleration according to rotation of the tire, storing pressure data, temperature data, and acceleration data measured by a sensor, varying a transmission period of at least one of the pressure data, the temperature data, or the acceleration data based on the acceleration data, and transmitting at least one of the pressure data, the temperature data, or the acceleration data according to the transmission period.

The varying a transmission period may include calculating a rotation speed of the tire based on the acceleration data, and variably setting the transmission period based on the rotation speed of the tire.

The varying a transmission period may include determining whether road surface characteristics change based on the acceleration data, and controlling the transmitter to transmit at least one of the pressure data, the temperature data, or the acceleration data based on the change in the road surface characteristics.

The tire monitoring method of present disclosure may further include storing the transmission period set differently depending on the rotation speed of the tire.

The determining whether road surface characteristics change may include storing reference acceleration data corresponding to the road surface characteristics.

The determining whether road surface characteristics change may include determining the road surface characteristics by comparing the acceleration data with the reference acceleration data.

According to the present disclosure, by estimating the tire rotation period, road surface state, and whether to change the road surface state using acceleration data measured by the sensor, and varying the data transmission period, so that only necessary data is transmitted, and unnecessary data transmission is suppressed to reduce power consumption of the sensor to maximize lifespan of the battery.

The effects of the present disclosure are not limited to the above effects, and it should be understood that they include all effects that can be inferred from the detailed description of the present disclosure or the composition of the disclosure described in the claims.

### BRIEF DESCRIPTION OF THE SEVERAL VIEWS OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a tire monitoring sensor device according to an embodiment of the present disclosure.

FIG. 2 is a diagram illustrating a state in which a tire monitoring sensor device is mounted on a tire according to an embodiment of the present disclosure.

FIG. 3 is a diagram for illustrating a method of measuring, by a tire monitoring sensor device, a tire-imposed load according to an embodiment of the present disclosure.

FIG. 4 is a diagram for illustrating a method of measuring, by a tire monitoring sensor, a rotation speed of a tire according to an embodiment of the present disclosure.

FIG. 5 is a diagram for illustrating a method of measuring, by a tire monitoring sensor device, a road surface state according to an embodiment of the present disclosure.

FIG. 6 is a diagram for illustrating a method of determining, by a tire monitoring sensor device, a change in road surface characteristics according to an embodiment of the present disclosure.

FIG. 7 is a flowchart of a tire monitoring method according to an embodiment of the present disclosure.

FIGS. 8 and 9 are flowcharts of a method of variably setting a transmission period of data according to an embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

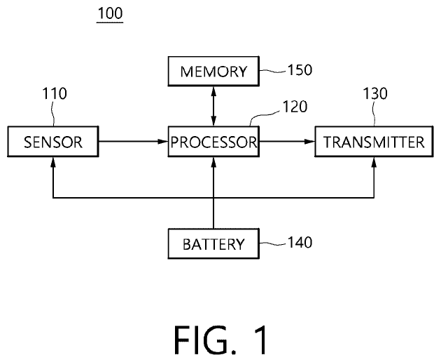

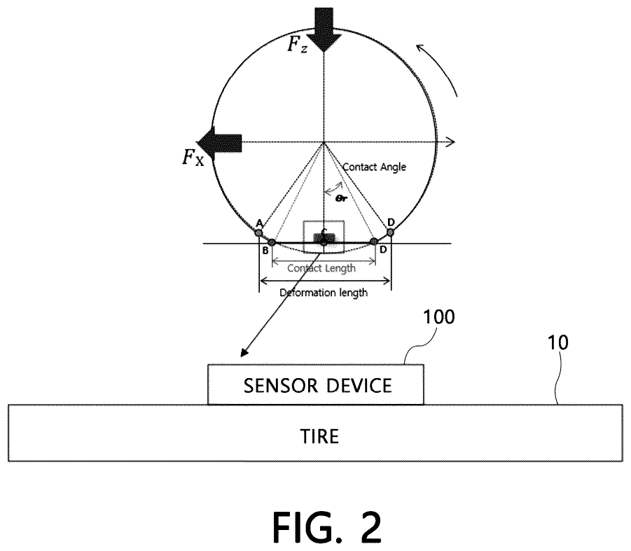

FIG. 1 is a block diagram of a tire monitoring sensor device according to an embodiment of the present disclosure, and FIG. 2 is a diagram illustrating a state in which a tire monitoring sensor device is mounted on a tire according to an embodiment of the present disclosure.

As shown in FIG. 1, the tire monitoring sensor device 100 according to an embodiment of the present disclosure may be configured to include a sensor 110, a processor 120, a transmitter 130, a battery 140, and a memory 150.

The tire monitoring sensor device 100 according to an embodiment of the present disclosure may be disposed inside the tire 10, but is not limited thereto. For example, only the sensor 110 may be disposed inside the tire 10, and the processor 120, the transmitter 130, the battery 140, and the memory 150 may be disposed around the tire 10.

The sensor 110 may be configured to include a pressure sensor that measures pressure inside the tire 10, a temperature sensor that measures temperature inside the tire 10, and an acceleration sensor that measures acceleration according to rotation of the tire 10.

The sensor 110 may be a tire monitoring sensor including the pressure sensor, the temperature sensor, and the acceleration sensor, and may be mounted on a tire inner liner of the tire 10 as shown in FIG. 2.

The memory 150 may store pressure data, temperature data, and acceleration data measured by the sensor 110.

The processor 120 may vary a transmission period of at least one of the pressure data, the temperature data, and the acceleration data based on the acceleration data.

The transmitter 130 may transmit at least one of the pressure data, the temperature data, or the acceleration data to a controller provided in the vehicle and an external server according to the transmission period variably set by the processor 120.

In this case, the transmitter 130 may communicate with the controller in a short-range wireless communication manner. For example, the short-range wireless communication method may be a Bluetooth low energy (BLE) method.

Accordingly, the controller or external server may monitor characteristics of a vehicle's tire air pressure, temperature, tire mileage, tire-imposed load, and road surface on which the vehicle travels, and the like based on the pressure data, the temperature data, and the acceleration data.

Here, the controller may display the characteristics of the vehicle's tire air pressure, temperature, tire mileage, tire-imposed load, and road surface on which the vehicle travels, and the like on a display provided in the vehicle.

The battery 140 may supply power to the sensor 110, the processor 120, and the transmitter 130.

On the other hand, the sensor 110, is a Tire Monitoring Sensor, which has a large physical quantity to be measured, operates with high sampling for precise measurement, and has a short data transmission period, thereby consuming the battery 140 in a short time.

Therefore, the tire monitoring sensor device according to an embodiment of the present disclosure aims to vary the data transmission period to minimize power consumption of the sensor 110 and to increase the lifespan of the battery.

To this end, the tire monitoring sensor device according to an embodiment of the present disclosure may determine the data transmission period by estimating the rotation period of the tire 10 and the characteristics of the road surface on which the vehicle travels using the acceleration data measured by the sensor 110.

Through this, it is possible to maximize the lifespan of the battery by reducing the power consumption of the sensor 110 by suppressing unnecessary data transmission.

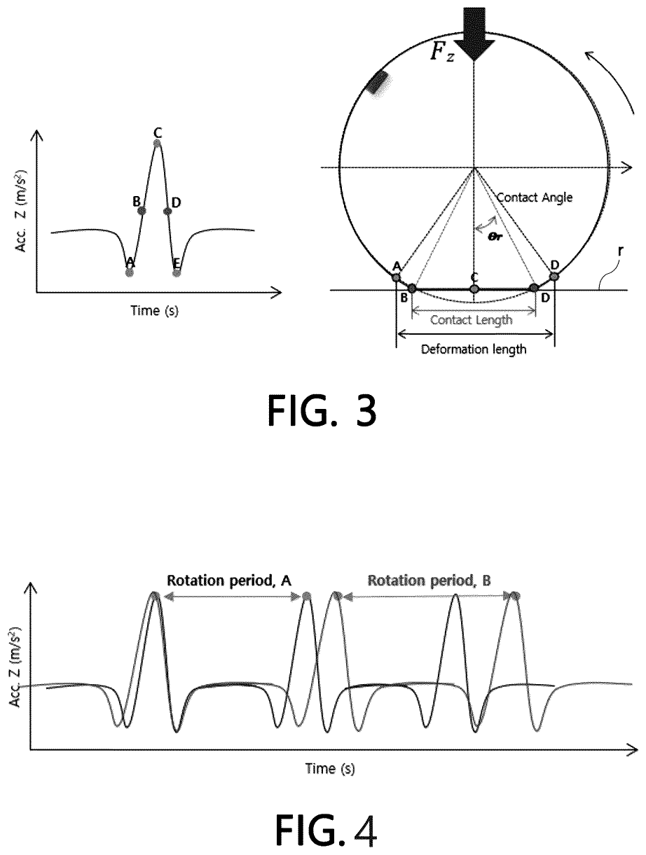

FIG. 3 is a diagram for illustrating a method of measuring, by a tire monitoring sensor device, a tire-imposed load according to an embodiment of the present disclosure.

As shown in FIG. 3, the sensor 110 may measure the Z-axis acceleration (Acc. Z). Here, the memory 150 may store the acceleration data in the form of a graph waveform in which the Z-axis acceleration measured by the sensor 110 changes over time.

When the vehicle travels and the tire 10 rotates along the road surface, the tire 10 has a region in which it is in contact with the road surface and a region in which it is deformed according to contact with the road surface.

Here, the length of the region in which the tire 10 is in contact with the road surface (Contact Length) is the length between a point B and a point D, and the length of the region in which it is deformed by the contact with the road surface (Deformation Length) is the length between a point A and a point E. At this time, a point C is located between the points B and D.

The Z-axis acceleration (Acc. Z) is minimum at the point A and point E, and maximum at the point C. Then, the Z-axis acceleration (Acc. Z) at the point B is intermediate between the Z-axis acceleration at the points A and C, and the Z-axis acceleration (Acc. Z) at the point D is intermediate between the Z-axis acceleration at the points A and E.

That is, the Z-axis acceleration (Acc. Z) has a minimum value at the point A, gradually increases to the point C via the point B and has a maximum value at the point C, and then gradually decreases to the point E via the point D and has a minimum value at the point E.

Here, the processor 120 may find the positions of the points B and D using the Z-axis acceleration (Acc. Z) and calculate the contact length of the area in which the tire 10 is in contact with the road surface, thereby estimating the tire-imposed load.

Specifically, the processor 120 may estimate that the tire-imposed load increases as the contact length of the region in which the tire 10 is in contact with the road surface increases, the tire-imposed load decreases as the contact length of the region in which the tire 10 is in contact with the road surface decreases. Here, the memory 150 may store a reference tire-imposed load according to the Contact Length of the region in which the tire 10 is in contact with the road surface, and the processor 120 may estimate the tire-imposed load based on the reference tire imposed load stored in the memory 150.

FIG. 4 is a diagram for illustrating a method of measuring, by a tire monitoring sensor, a rotation speed of a tire according to an embodiment of the present disclosure.

Referring to FIG. 4, when the vehicle travels and the tire 10 rotates along a road surface, a pattern of the Z-axis acceleration (Acc. Z) repeats at a predetermined period according to a rotation speed of the tire 10.

For example, when the tire 10 rotates at a first speed, the pattern of Z-axis acceleration (Acc. Z) repeats in a first rotation period (Rotation period, A) according to the first speed, and when the tire 10 rotates at a second speed slower than the first speed, the pattern of the Z-axis acceleration (Acc. Z) repeats in a second rotation period (Rotation period, B) slower than the first rotation period (Rotation period, A) according to the second speed.

The processor 120 may calculate the rotation speed of the tire 10 based on the acceleration data.

Specifically, the processor 120 may calculate a time between the maximum value and the maximum value of the pattern of the Z-axis acceleration (Acc. Z) as the rotation period.

In addition, the processor 120 may apply the rotation period to Equation 1 below to calculate the rotation speed Vt of the tire 10.

$$Vt = \frac{2 π Rt}{Pr} \qquad [ Equation 1 ]$$

Here, Rt is the radius of tire 10 and Pr is the rotation period of tire 10.

The processor 120 may vary the transmission period of at least one of temperature data, pressure data, and acceleration data of the tire 10 based on the rotation speed of the tire 10.

Specifically, the memory 150 may store a transmission period set differently depending on the rotation speed of the tire 10, and the processor 120 may control the transmitter 130 to transmit the data at the transmission period corresponding to the rotation speed of the tire 10 stored in the memory 150.

Here, the transmission period may be set by dividing the rotation speed into a plurality of sections.

The memory 150 may store a reference X-axis acceleration (Acc. X) pattern for each rotation speed of the tire 10.

Here, the processor 120 may determine the rotation speed of the tire 10 by comparing the X-axis acceleration pattern measured by the sensor 110 with the reference X-axis acceleration pattern stored in the memory 150.

In addition, the processor 120 may control the transmitter 130 to transmit the data based on the change in the rotation speed section of the tire 10.

This is because when the rotation speed section of the tire 10 changes, the external force applied to the tire 10 increases, thereby increasing the need to monitor the tire 10.

In addition, the processor 120 may vary the transmission period in proportion to the rotation speed of the tire 10.

For example, the processor 120 may set the transmission period shorter as the rotation speed of the tire 10 increases.

This is to precisely measure the condition of the tire 10 by shortening the transmission period because the external force applied to the tire 10 increases as the rotation speed of the tire 10 increases, thereby increasing the necessity of monitoring the tire 10.

On the contrary, the processor 120 may set the transmission period shorter as the rotation speed of the tire 10 decreases.

This is to prevent unnecessary data transmission by increasing the transmission period because the need to monitor the tire 10 is reduced because the external force applied to the tire 10 decreases as the rotation speed of the tire 10 decreases.

As described above, the tire monitoring sensor device according to an embodiment of the present disclosure estimates the rotation period of the tire 10 using the acceleration data measured by the sensor 110 to determine the data transmission period, so that only necessary data is transmitted, and unnecessary data transmission is suppressed to reduce the power consumption of the sensor 110 to maximize the lifespan of the battery.

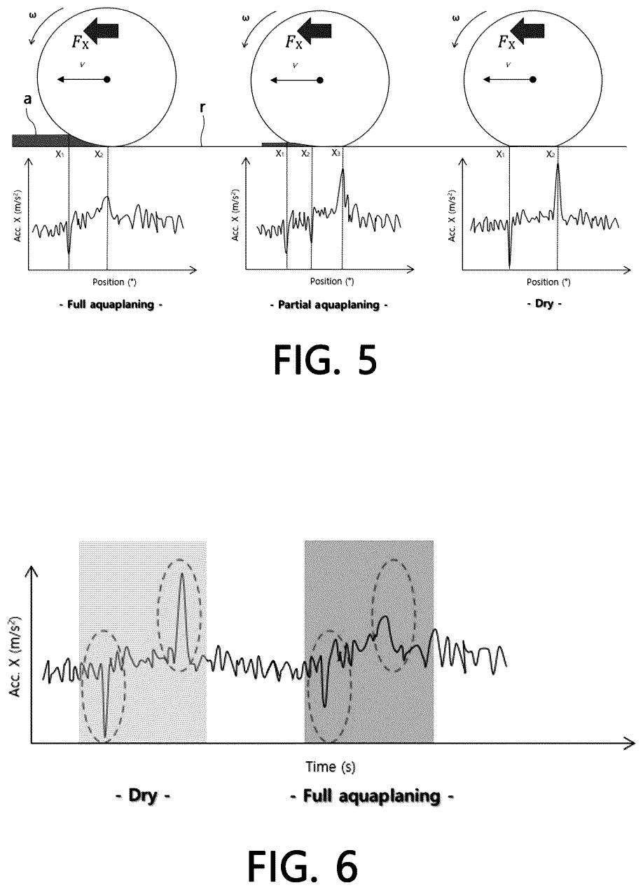

FIG. 5 is a diagram for illustrating a method of measuring, by a tire monitoring sensor device, a road surface state according to an embodiment of the present disclosure.

Referring to FIG. 5, the processor 120 may determine the road surface characteristics based on the acceleration data. Here, the road surface characteristics may include a state in which Full aquaplaning, Partial aquaplaning, Dry, Pot-hole, and Bump exist, respectively.

FIG. 5 shows the X-axis acceleration according to tire rotation (Acc. X) when the road surface state is the Full aquaplaning state, Partial aquaplaning state, and Dry state.

As shown in FIG. 5, when the road surface is in the Full aquaplaning state, the X-axis acceleration (Acc. X) has a section minimum value at a point X1 where the tire 10 is in contact with the aquaplaning (a) during rotation of the tire 10, and has a section maximum value at a point X2 where the tire 10 is in contact with the road surface.

In addition, when the road surface is in the Partial aquaplaning state, the X-axis acceleration (Acc. X) has a first section minimum value at a point X1 where the tire 10 is in contact with the aquaplaning (a) during rotation of the tire 10, a second section minimum value at a point X2 where the tire 10 is in contact with the road surface, and a section maximum value at a point X3 where the tire 10 is in contact with the road surface.

Here, the processor 120 may determine the degree of the aquaplaning of the road surface by calculating a distance between the point X2 at which the tire 10 starts contact with the road surface and the point X3 at which the tire 10 ends contact with the road surface, and may vary the data transmission period according to the degree of the aquaplaning of the road surface.

The memory 150 may store a reference X-axis acceleration (Acc. X) pattern for each height of the aquaplaning of the road surface.

Here, the processor 120 may compare the X-axis acceleration pattern measured by the sensor 110 with the reference X-axis acceleration pattern stored in the memory 150 to determine the degree of aquaplaning on the road surface.

In addition, when the road surface is the Dry state, the X-axis acceleration (Acc. X) has a second section minimum value at a point X1 at which the tire 10 starts contact with the road surface, and has a section maximum value at a point X2 at which the tire 10 ends contact with the road surface.

When the Pot-hole and Bump are present on the road surface, a specific X-axis acceleration (Acc. X) pattern different from that of a flat road surface is obtained.

As such, the processor 120 may vary the transmission period of data according to the road surface characteristics. Here, the memory 150 may store the transmission period of data set for each road surface characteristic.

For example, when the road surface is in a Full aquaplaning state, the processor 120 may set the transmission period of data shorter than when the road surface is in the Dry state.

As described above, the tire monitoring sensor device according to the embodiment of the present disclosure varies the external force applied to the tire 10 depending on the road surface state, so by varying the transmission period depending on the road surface state, only necessary data is transmitted, and unnecessary data transmission is suppressed to reduce the power consumption of the sensor 110 to maximize the lifespan of the battery.

The memory 150 may store a reference X-axis acceleration (Acc. X) pattern for each road surface characteristic. Here, the reference X-axis acceleration (Acc. X) pattern reflects the type and diameter of the tire 10, and may be set differently depending on the rotation speed of the tire 10 even if the road surface characteristics are the same.

For example, the reference X-axis acceleration (Acc. X) pattern may be an acceleration pattern corresponding to a state in which Full aquaplaning, Partial aquaplaning, Dry, Pot-hole, and Bump exist, respectively.

Here, the processor 120 may determine the road surface characteristics by comparing the X-axis acceleration pattern measured by the sensor 110 with the reference X-axis acceleration pattern stored in the memory 150.

For example, when the similarity between the X-axis acceleration pattern measured by the sensor 110 and the reference X-axis acceleration pattern in the Full aquaplaning state is equal to or greater than a reference value (e.g., 80%), the processor 120 may estimate the current road surface state as the Full aquaplaning state.

In addition, the processor 120 may control the transmitter 130 to estimate the road surface state and transmit the data whenever an event occurs on the road surface, for example, whenever it is estimated that there is the Pot-hole, and Bump.

This is because when an event occurs on the road surface, the external force applied to the tire 10 increases, thereby increasing the need to monitor the tire 10.

FIG. 6 is a diagram for illustrating a method of determining, by a tire monitoring sensor device, a change in road surface characteristics according to an embodiment of the present disclosure.

The processor 120 may determine whether road surface characteristics change based on the acceleration data.

Specifically, referring to FIG. 6, the processor 120 may determine that the state changes from the Dry to the Full aquaplaning based on the X-axis acceleration pattern.

Here, the processor 120 may compare the X-axis acceleration pattern measured by the sensor 110 with the reference X-axis acceleration pattern stored in the memory 150 to determine whether the road surface characteristics change.

In addition, the processor 120 may control the transmitter 130 to transmit at least one of the pressure data, the temperature data, and the acceleration data based on the change in the road surface characteristics.

This is because the need to monitor the tire 10 increases because the external force applied to the tire 10 increases when the road surface characteristic changes.

As described above, the tire monitoring sensor device according to the embodiment of the present disclosure estimates whether to change the road surface state using the acceleration data measured by the sensor 110 to determine the data transmission period, so that only necessary data is transmitted, and unnecessary data transmission is suppressed to reduce the power consumption of the sensor 110 to maximize the lifespan of the battery.

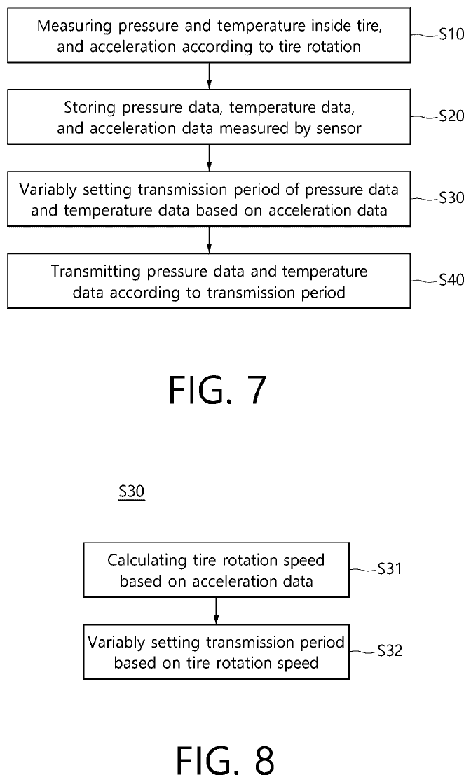

FIG. 7 is a flowchart of a tire monitoring method according to an embodiment of the present disclosure, and

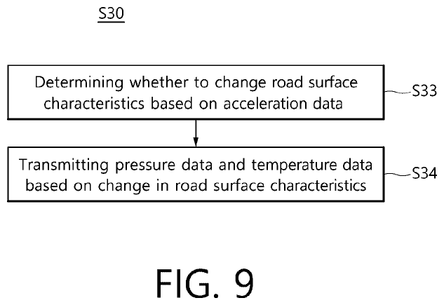

FIGS. 8 and 9 are flowcharts of a method of variably setting a transmission period of data according to an embodiment of the present disclosure.

Hereinafter, a tire monitoring method according to an embodiment of the present disclosure will be described with reference to FIGS. 7 to 9.

The tire monitoring method according to an embodiment of the present disclosure first stores a transmission period differently set according to a rotation speed of the tire 10 and road surface characteristics and reference acceleration data corresponding to the road surface characteristics in the memory 150.

Next, as a method for monitoring the tire 10 using the sensor device 110, first, a pressure and temperature inside the tire 10 and an acceleration according to rotation of the tire 10 are measured (step S10).

Next, pressure data, temperature data, and acceleration data measured by the sensor 110 are stored in the memory 150 (step S20).

Next, transmission period of at least one of the pressure data, the temperature data, and the acceleration data is variably set based on the acceleration data measured by the sensor 110 (step S30).

In this case, as shown in FIG. 8, the rotation speed of the tire 10 may be calculated based on the acceleration data (step S31), and the transmission period may be variably set based on the rotation speed of the tire 10 (step S32).

That is, the rotation period of the tire 10 is calculated using the repetition pattern of the acceleration data, and the rotation speed of the tire 10 is calculated using the rotation period.

In addition, the transmitter 130 may be controlled to transmit the data at a transmission period corresponding to the rotation speed of the tire 10 stored in the memory 150.

Here, the transmission period may be set by dividing the rotation speed into a plurality of sections.

In addition, the transmitter 130 is controlled to transmit the data based on a change in the rotation speed section of the tire 10. This is because the external force applied to the tire 10 increases when the rotation speed section of the tire 10 changes, thereby increasing the need to monitor the tire 10.

In addition, the transmission period may be varied in proportion to the rotation speed of the tire 10.

For example, the transmission period may be set shorter as the rotation speed of the tire 10 increases. This is to precisely measure the condition of the tire 10 by shortening the transmission period because the external force applied to the tire 10 increases as the rotation speed of the tire 10 increases, thereby increasing the necessity of monitoring the tire 10.

On the other hand, the transmission period may be set shorter as the rotation speed of the tire 10 decreases. This is to prevent unnecessary data transmission by increasing the transmission period because the need to monitor the tire 10 is reduced because the external force applied to the tire 10 decreases as the rotation speed of the tire 10 decreases.

As described above, the tire monitoring method according to an embodiment of the present disclosure estimates the rotation period of the tire 10 using the acceleration data measured by the sensor 110 to determine the data transmission period, so that only necessary data is transmitted, and unnecessary data transmission is suppressed to reduce the power consumption of the sensor 110 to maximize the lifespan of the battery.

In addition, the transmission period of the data may be varied according to the road surface characteristics. Here, the memory 150 may store the data transmission period set for each road surface characteristic.

For example, when the road surface is in a Full aquaplaning state, the transmission period of the data may be set shorter than when the road surface is in a Dry state.

As described above, the tire monitoring method according to the embodiment of the present disclosure varies the external force applied to the tire 10 depending on the road surface state, so by varying the transmission period depending on the road surface state, only necessary data is transmitted, and unnecessary data transmission is suppressed to reduce the power consumption of the sensor 110 to maximize the lifespan of the battery.

The memory 150 may store a reference acceleration pattern for each road surface characteristic. Here, the reference acceleration pattern reflects the type and diameter of the tire 10, and may be set differently depending on the rotation speed of the tire 10 even if the road surface characteristics are the same.

For example, the reference acceleration pattern may be an acceleration pattern corresponding to a state in which Full aquaplaning, Partial aquaplaning, Dry, Pot-hole, and Bump exist, respectively.

Here, the road surface characteristics may be determined by comparing the acceleration pattern measured by the sensor 110 with the reference acceleration pattern stored in the memory 150.

For example, when the similarity between the acceleration pattern measured by the sensor 110 and the reference acceleration pattern in the Full aquaplaning state is equal to or greater than a reference value (e.g., 80%), the current road surface state may be estimated as the Full aquaplaning state.

In addition, the transmitter 130 may be controlled to transmit the data whenever an event occurs on the road surface, for example, whenever it is estimated that there is the Pot-hole, and Bump.

This is because when an event occurs on the road surface, the external force applied to the tire 10 increases, thereby increasing the need to monitor the tire 10.

In addition, whether to change the road surface characteristics is determined based on the acceleration data (step S33), the transmitter 130 controls the transmitter 130 to transmit at least one of the pressure data, the temperature data, and the acceleration data based on the change in the road surface characteristics (step S34).

In this case, the reference acceleration data corresponding to the road surface characteristics is stored, and the road surface characteristics are determined by comparing the acceleration data measured by the sensor 110 with the reference acceleration data.

Next, the transmitter 130 transmits at least one of the pressure data, the temperature data, and the acceleration data according to the transmission period (step S40).

In this case, the transmitter 130 may transmit the data to the controller provided in the vehicle and the external server according to the transmission period variably set by the processor 120.

Accordingly, the controller or the external server may monitor characteristics of the tire air pressure, temperature, tire milage, tire-imposed load, and road surface on which the vehicle travels and the like based on the pressure data, the temperature data, and the acceleration data.

Here, the controller may display the characteristics of the tire air pressure, temperature, tire milage, tire-imposed load, and road surface on which the vehicle travels, and the like on the display provided in the vehicle.

As described above, the tire monitoring method according to the embodiment of the present disclosure, estimates the rotation period of the tire 10, road surface state, and where to change the road surface state using the acceleration data measured by the sensor 110, and varying the data transmission period, so that only necessary data is transmitted, and unnecessary data transmission is suppressed to reduce the power consumption of the sensor 110 to maximize the lifespan of the battery.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

1. A sensor device for monitoring a tire, the device comprising:
a sensor configured to measure a temperature and pressure of a tire, and an acceleration according to rotation of the tire;
a memory configured to store temperature data, pressure data, and acceleration data measured by the sensor;
a processor configured to vary a transmission period of at least one of the temperature data, the pressure data, or the acceleration data based on the acceleration data; and
a transmitter configured to transmit at least one of the temperature data, the pressure data, or the acceleration data according to the transmission period.

2. The device of claim 1, wherein the processor is configured to calculate a rotation speed of the tire based on the acceleration data.

3. The device of claim 2, wherein the processor is configured to vary the transmission period based on the rotation speed of the tire.

4. The device of claim 1, wherein the processor is configured to determine road surface characteristics based on the acceleration data.

5. The device of claim 1, wherein the processor is configured to determine whether the road surface characteristics change based on the acceleration data.

6. The device of claim 5, wherein the processor is configured to control the transmitter to transmit at least one of the pressure data, the temperature data, and the acceleration data based on the change in the road surface characteristics.

7. The device of claim 6, wherein the memory is configured to store the transmission period determined differently depending on the rotation speed of the tire.

8. The device of claim 7, wherein the memory is configured to store reference acceleration data corresponding to the road surface characteristics.

9. The device of claim 8, wherein the processor is configured to determine the road surface characteristics by comparing the acceleration data with the reference acceleration data.

10. A method for monitoring a tire using a sensor device, the method comprising:
measuring a pressure and temperature inside a tire and an acceleration according to rotation of the tire;
storing pressure data, temperature data, and acceleration data measured by a sensor;
varying a transmission period of at least one of the pressure data, the temperature data, or the acceleration data based on the acceleration data; and
transmitting at least one of the pressure data, the temperature data, or the acceleration data according to the transmission period.

11. The method of claim 10, wherein the varying a transmission period comprises:
calculating a rotation speed of the tire based on the acceleration data; and
varying the transmission period based on the rotation speed of the tire.

12. The method of claim 10, wherein the varying a transmission period comprises:
determining whether road surface characteristics change based on the acceleration data; and
controlling the transmitter to transmit at least one of the pressure data, the temperature data, or the acceleration data based on the change in the road surface characteristics.

13. The method of claim 11, further comprising:
storing the transmission period set differently depending on the rotation speed of the tire.

14. The method of claim 12, wherein the determining whether road surface characteristics change comprises:
storing reference acceleration data corresponding to the road surface characteristics.

15. The method of claim 14, wherein the determining whether road surface characteristics change comprises:
determining the road surface characteristics by comparing the acceleration data with the reference acceleration data.
